(19) United States
(12) Patent Application Publication
(10) Pub. No.: US 2026/0087128 A1
(43) Pub. Date: Mar. 26, 2026

(54) Method for Automatically Issuing Incident Notifications

(71) Applicant: Varonis Systems, Inc., New York, NY (US)

(72) Inventors: Ronen Halbani, Kadima-Zoran (IL); Amit Cohen, Kfar-Saba (IL); John Eugene Neystadt, Kfar-Saba (IL)

(21) Appl. No.: 18/896,239

(22) Filed: Sep. 25, 2024

(51) Int. Cl. G06F 21/55

(52) U.S. Cl. CPC G06F 21/554

(57) ABSTRACT

The present techniques provide a method for automatically and quickly providing information after a data breach or incident in relation to data has occurred. The present application provides a method for issuing data incident notifications when data items naming specific entities have been accessed by someone who should not have access to them. This enables the entities to obtain information on the data items they are named in and which have been accessed. An index may be used to quickly identify the data items which are subject to an incident and which name entities. After these data items are identified, a notification list can be generated that shows each data item naming an entity. A system administrator or security officer can then generate a data incident notification to notify an entity about the impacted data items in which they are named.

### FIELD

The present application generally relates to a method for automatically and quickly providing information after a data breach or incident in relation to data has occurred. In particular, the present application provides a method for issuing data incident notifications when data items naming specific entities have been accessed by someone who should not have access to them. This enables the entities to obtain information on the data items that they are named in and which have been accessed.

### BACKGROUND

IT security officers face the critical task of providing detailed information and timely analysis following a data breach or event investigation. While identifying breached data and its ownership is essential, it is not always sufficient. Security officers must also understand the context of the data. This is because if there has been a breach, it is useful for any named in data items impacted by the breach to know exactly what data relating to them has been accessed. For example, a person may not consider it to be a problem if the breached data items are emails they have sent about office stationery supplies to their colleagues, but they may consider it to be more problematic if the breached data items include their personnel files.

The challenge is bigger in the unstructured data domain, especially when dealing with large-scale breaches involving millions of documents. Even if the security officer could leverage existing solutions to obtain breached documents (such as emails, presentations, or plain text files) and classify them, linking each document to a specific entity based on its contents remains a complex and time-consuming task.

The present applicant has therefore recognised the need for an improved way to quickly generate informative data incident notifications.

### SUMMARY

In a first approach of the present techniques, there is provided a computer-implemented method for automatically issuing a data incident notification, the method comprising: determining an incident has occurred with respect to at least one data storage device that stores a plurality of data items; obtaining a data item and entity index for the at least one data storage device, wherein, for each data storage device, the data item and entity index comprises a plurality of index entries, wherein each index entry comprises an identifier for one data item of the plurality of data items stored by the data storage device together with an entity identifier for each entity named within content of each data item; generating, using the obtained data item and entity index for the at least one data storage device, a notification list comprising each data item that names at least one entity, and the corresponding entity identifier of the entity; and determining, for each entity identifier in the notification list, whether to generate a data incident notification.

Advantageously, the present techniques make use of an index to quickly identify the data items which are subject to an incident (such as a data breach or violation of a security policy), and which name entities. Once these data items have been identified, it is possible to generate a notification list that shows each data item naming an entity. A system administrator or security officer may then decide whether to generate a data incident notification to notify an entity about the impacted data items in which they are named.

The method may be implemented by a central server or platform device that is arranged to monitor data incidents with respect to at least one data storage device.

The or each data storage device may be any computing device within the environment. Examples of computing devices include laptops, desktop computers, smartphones, servers, and so on. More generally, the at least one data storage device may be any data storage within the environment, which includes file servers and any cloud-based data storage, such as those provided by Microsoft SharePoint, Google Drive, and so on.

The data items may be any one or more of the following types of data item: an email, a document, a file, a text file, a folder, an image, a video, an audio file, a diagram, a geographical map, a medical image, a medical data file, a portable document format file, and any other specialised file type. It will be understood that this is a non-exhaustive and non-limiting list of example data item types.

Each “entity” may be any individual within an environment (e.g. a business, workplace, organisation, department within an organisation, etc.), or may be customers, vendors, suppliers and other third parties (both organisations and individuals) with whom people in the environment interact. In some cases, all entities within an environment may be included within the index. In other cases, only specific entities within an environment may be included with the index. The specific entities may be, for example, individuals whose data is concerned more valuable or important, such as those in the C-suite of a business, or in a business-critical or business sensitive department.

Obtaining a data item and entity index may comprise retrieving the index from storage. In some cases, the index may be stored by the central server or platform device which performs the method to determine whether to generate a data incident notification. In other cases, the index may be stored by another device that is communicatively coupled to the central server/platform device.

In some cases, the method may further comprise issuing, for at least one entity identifier in the notification list, a data incident notification responsive to determining a data incident notification is to be issued for the at least one entity identifier. That is, when it is determined that a data incident notification is to be generated with respect to a specific entity identifier, the method comprises issuing the required data incident notification. The central server or platform device which performs the method may issue the data incident notification itself, or may instruct another device to do so.

In some cases, the method may further comprise: transmitting, responsive to determining a data incident notification is to be issued, the generated notification list to a system administrator, thereby enabling the system administrator to notify each entity about the data items in which they are named and that are subject to the incident. This may be advantageous because instead of automatically sending notifications to each entity immediately, the system administrator can decide whether the incident is serious enough to inform the entity, or can inform entities based on a priority order or seriousness level. This can be useful because it may avoid mass-panic and ensure that more serious breaches or violations are actioned first.

There are different ways the occurrence of an incident can be determined.

In one example, determining an incident has occurred may comprise: receiving an alert that a data policy associated with at least one data item stored by the at least one data storage device has been violated. In this example, the alert arises from within the system/environment being monitored itself (i.e. the system or environment in which the data storage devices are located). For example, at least one data management policy may be applied to data items. The data management policy may be any security and/or data retention policy. For example, the data management policy may be a policy that prevents certain data items from being transmitted outside of the environment, or that controls who can access the data items within the environment, or that controls how long data items should be retained before they can be deleted/purged, or moved from primary storage to secondary or tertiary storage. The data management policy may be used to implement national or regional regulation or law, such as the European Union's General Data Protection Regulation (GDPR), or the USA's Data Privacy Protection laws. The alert may then be raised based on a violation of a data management policy.

Generating a notification list may comprise: identifying, in the index, an index entry corresponding to the at least one data item; selecting, from each identified index entry, each index entry comprising an entity identifier; and extracting, for each selected index entry, the identifier for the data item and the entity identifier for each entity named within content of the data item. In other words, the index may be used to quickly determine which of the impacted data items names an entity, so that a notification list can be generated that includes information about the impacted data items and the named entity. Thus, the notification list does not include data items that do not name entities within their content.

Determining, for each entity identifier in the notification list, whether to generate a data incident notification may comprise: retrieving, for the entity identifier, a notification policy for the entity corresponding to the entity identifier, wherein the notification policy comprises a condition for generating a data incident notification. In other words, each entity may be associated with a notification policy that specifies when a data incident notification should be issued. This may advantageously ensure that for some low-level individuals in an organisation notifications are not issued for all incident types as this may not be necessary, or may ensure that notifications are issued for many/all incident types for high-level individuals (e.g. C-suite). This can ensure notification traffic is optimised.

When the condition for generating a data incident notification is satisfied, the method may further comprise: transmitting, for the entity, the identifier for each data item in which the entity is named, and the entity identifier to a system administrator.

In some cases, retrieving a notification policy for the entity may comprise: retrieving a specific, pre-determined notification policy for the entity. Thus, a notification policy that is specific to the entity, and is pre-specified or pre-determined for the entity, may exist. This may be appropriate for certain individuals in an organisation, e.g. C-suite.

In other cases, retrieving a notification policy for the entity may comprise: determining a risk level associated with the entity; and retrieving a notification policy based on the determined risk level. Thus, entities may be associated with a risk level (e.g. no risk, low risk, medium risk, high risk), and a notification policy that is associated with each risk level may exist. This may be an efficient way to specify notification policies for an organisation.

Determining a risk level associated with the entity may comprise determining any of: a risk level of the entity; a risk level of a role performed by the entity; a risk level of a group of which the entity is a member.

When the notification list contains two or more entities, the method may further comprise: ordering the two or more entities into an order based on the determined risk level of the entities; and transmitting, in a same order as the order of the entities, the identifier for each data item in which each entity is named, and the entity identifier to a system administrator. Thus, information may be ordered based on risk level, so that the system administrator can take action based on the ordered information, which ensures high risk level entities are notified before low risk level entities. This is also useful because the system administrator may otherwise not know which entities are priorities.

In another example, determining an incident has occurred may comprise: receiving information from an external source that an incident has occurred with respect to the at least one data storage device. In this example, the alert arises from outside of the system/environment being monitored itself (i.e. the system or environment in which the data storage devices are located). Once the alert has been received, there are at least two techniques to determine which data storage device(s) has potentially been impacted. One technique involves receiving, within the alert itself, an indication of which data storage device(s) is (are) impacted. In this case, the alert may be received from a third party that for example, provides data loss prevention services. It will be understood that any external source may provide the alert. The method may then comprise scanning the data items stored by the indicated data storage device(s) to generate the notification list. An alternative technique involves the central server/platform device triggering an alert with respect to a specific data storage device, or with respect to a location in which one or more data storage devices are located.

In this case, generating a notification list may comprise: identifying, in the index, each index entry comprising an entity identifier; and extracting, for each identified index entry, the identifier for the data item and the entity identifier for each entity named within content of the data item.

Determining, for each entity identifier in the notification list, whether to generate a data incident notification may comprise: automatically transmitting the generated notification list to a system administrator, thereby enabling the system administrator to notify each entity about the data items in which they are named and that are subject to the incident.

In a second approach of the present techniques, there is provided a system for automatically issuing a data incident notification, the system comprising: a plurality of data storage devices, each data storage device storing a plurality of data items; a data item and entity index for each data storage device, wherein, for each data storage device, the data item and entity index comprises a plurality of index entries, wherein each index entry comprises an identifier for one data item of the plurality of data items stored by the data storage device together with an entity identifier for each entity named within content of each data item; and at least one processor coupled to memory, arranged for: determining an incident has occurred with respect to at least one of the data storage devices; obtaining the data item and entity index for the at least one data storage device where the incident has occurred; generating, using the obtained data item and entity index for the at least one data storage device, a notification list comprising each data item that names at least one entity, and the corresponding entity identifier of the entity; and determining, for each entity identifier in the notification list, whether to generate a data incident notification.

The features described above with respect to the first approach apply equally to the second approach and therefore, for the sake of conciseness, are not repeated.

In a third approach of the present techniques, there is provided a computer-implemented method for automatically generating a data item and entity index for use in issuing data incident notifications, the method comprising: receiving an update whenever a new data item has been stored in a data storage device; obtaining, for the new data item, an identifier for the new data item; obtaining an entity identifier for each entity named within content of the new data item; and adding an index entry to the data item and entity index, wherein the index entry comprises the identifier for the new data item and the entity identifier for each entity named within content of the new data item.

Thus, the present techniques provide a way to generate an index which can be used to generate notifications when an incident has occurred with respect to data items. The index may be considered a two-way index. That is, the index can be used to identify information in two ways: one way is to look up entity identifiers, which shows each data item in which the corresponding entity is named (e.g. entity A: doc ID 1234, doc ID 5678); the other way is to look up data items, which shows each entity named in the data item (e.g. doc ID 1234: entity A, entity Z).

Obtaining an entity identifier may comprise: obtaining a list of entities and corresponding entity identifiers; determining whether any entities in the obtained list appear in the content of the new data item; and extracting from the list, when an entity appears in the content, the entity identifier of the entity. The list of entities may be every individual in an organisation/environment (e.g. all employees), or may be only a select set of individual in an organisation/environment.

The method may further comprise: adding information about a notification policy for the entity in the index entry, wherein the notification policy comprises a condition for generating a data incident notification.

The method may further comprise: adding information about a risk level associated with the entity to the index entry.

In a fourth approach of the present techniques, there is provided an apparatus for automatically generating a data item and entity index for use in issuing data incident notifications, the apparatus comprising: at least one processor coupled to memory for: receiving an update whenever a new data item has been stored in a data storage device; obtaining, for the new data item, an identifier for the new data item; obtaining an entity identifier for each entity named within content of the new data item; and adding an index entry to the data item and entity index, wherein the index entry comprises the identifier for the new data item and the entity identifier for each entity named within content of the new data item.

The features described above with respect to the third approach apply equally to the fourth approach and therefore, for the sake of conciseness, are not repeated.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

### BRIEF DESCRIPTION OF THE DRAWINGS

Implementations of the present techniques will now be described, by way of example only, with reference to the accompanying drawings, in which:

FIG. 1 is a block diagram of a process to generate a data item and entity index;

FIG. 2 is a block diagram of a process to generate data incident notifications using a data item and entity index; and

FIG. 3 is a block diagram of a system for automatically generating data incident notifications.

### DETAILED DESCRIPTION OF THE DRAWINGS

Broadly speaking, the present techniques provide a method for automatically and quickly providing information after a data breach or incident in relation to data has occurred. In particular, the present application provides a method for issuing data incident notifications when data items naming specific entities have been accessed by someone who should not have access to them. This enables the entities to obtain information on the data items that they are named in and which have been accessed. Advantageously, the present techniques make use of an index to quickly identify the data items which are subject to an incident (such as a data breach or violation of a security policy), and which name entities. Once these data items have been identified, it is possible to generate a notification list that shows each data item naming an entity. A system administrator or security officer can then decide whether to generate a data incident notification to notify an entity about the impacted data items in which they are named.

The present techniques involve generating an index based on entity information. As mentioned above, it is necessary to obtain a list of entities who are to be included in the index. This may be done in a number of ways. For example, in one example, a list of every individual (e.g. employee) within an organisation may be used. In other examples, a list of specific individuals within an organisation may be used.

In another example, entity information may be extracted from data items and other sources within the environment. In such cases, the process to extract entity information may comprise: extracting entity data specific to the environment from data sources within the environment (such as databases, active directories, and applications). The process may comprise: standardising the data in a specific format, so that all the entity information is in the same specific format for each of indexing. In one example, the specific format may be a CSV format, which may include the following columns: Entity ID—a unique identifier (numeric or alphanumeric) associated with a single entity within the environment; Entity Descriptors—additional columns associated with the entity (numeric or alphanumeric strings); and Entity Weighting—to distinguish and prioritize based on entity groups (e.g. certain users are more important and are able to access more secure or confidential documents).

Different entity lists may be generated for an environment. For example, a separate entity list may be generated for different entity types, such as customers, vendors, employees, etc. Alternatively, a single entity list may be generated for all entity types.

In some cases, each entity may be associated with a predefined risk indication or risk level. The risk level may be used later during the notification process.

Once the entity information has been obtained, it is possible to scan all data items within the environment to determine which data items each entity is named in. This process does not identify data items that entities are authors of (e.g. the author of a Word document), but only those data items in which entities are named within the content (e.g. within the content of a Word document). The scanning process may use exact matches to identify data items in which entities are named. That is, for an entity Jane A. Smith, any data item that includes “Jane A. Smith” in the content is identified. Additionally or alternatively, the scanning process may use approximate matching. That is, for an entity Jane A. Smith, any data item that includes “Jane Smith” or “Jane A. S.” in the content is identified.

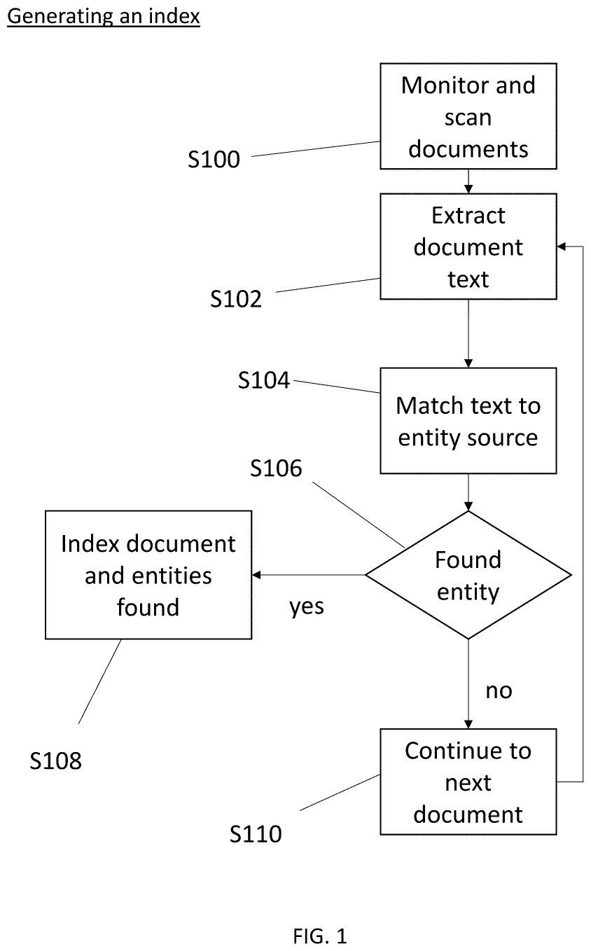

FIG. 1 is a block diagram of a process to generate a data item and entity index. The process may be a computer-implemented method for automatically generating a data item and entity index for use in issuing data incident notifications. The method may comprise: receiving an update whenever a new data item has been stored in a data storage device (step S100); obtaining, for the new data item, an identifier for the new data item; obtaining an entity identifier for each entity named within content of the new data item; and adding an index entry to the data item and entity index, wherein the index entry comprises the identifier for the new data item and the entity identifier for each entity named within content of the new data item (step S108).

Thus, the present techniques provide a way to generate an index which can be used to generate notifications when an incident has occurred with respect to data items. The index may be considered a two-way index. That is, the index can be used to identify information in two ways: one way is to look up entity identifiers, which shows each data item in which the corresponding entity is named (e.g. entity A: doc ID 1234, doc ID 5678); the other way is to look up data items, which shows each entity named in the data item (e.g. doc ID 1234: entity A, entity Z).

In some cases, generating the two-way index comprises building two indexes.

One index may be for data items. Each data item is associated with a unique identifier. For each data item in the index, the index includes a linked list containing the unique identifier of every entity found within that data item. The index may optionally store relevant metadata about the data item (e.g., creation date, author, etc.). For example, entries in the data item index may include entries such as: Document A→entity X, entity Z; Document B→entity b, entity c, entity x. To generate this index, data items stored in the at least one data storage device may be scanned to determine whether they contain any entities. The index may be generated by listing the unique identifier of each data item, and then each entity contained within that data item. E.g.:

| Data item unique ID | Entity IDs for each entity in data item |
|---|---|
| A | X123, Z456 |
| B | B234, C789, X123 |
| C | D675 |

The other index may be for entities. Each entity is associated with a unique entity identifier. For each entity in the index, the index includes a linked list containing the unique identifiers of each data item in which the entity is named. For example, entries in the entity index may include entries such as: Entity X→Document A, Document B; Entity Z→Document A. To generate this index, data items stored in the at least one data storage device may be scanned to determine whether they contain any entities. The index may be generated by listing the unique identifier of each entity, and then each data item that contains that entity. E.g.:

| Entity ID | Linked data items |
|---|---|
| X123 | A, B |
| Z456 | A |
| B234 | B |

To enable the index(es) to be quickly searched in the event of a data incident, the present techniques may also provide an interface to enable the index(es) to be searched. The interface may be an API or web-based interface, which can be used to execute searches on the index/two-way index. For example, if a specific data item is entered into the search interface, the interface returns each entity (or the identifiers thereof) named within the index in relation to that data item. Similarly, if a specific entity is entered into the search interface, the interface returns each data item (or the identifiers thereof) in which the entity is mentioned.

The method may comprise extracting text from the data item (step S102). Obtaining an entity identifier may comprise: obtaining a list of entities and corresponding entity identifiers; determining whether any entities in the obtained list appear in the content of the new data item (step S104); and extracting from the list, when an entity appears in the content (step S106), the entity identifier of the entity. The list of entities may be every individual in an organisation/environment (e.g. all employees), or may be only a select set of individual in an organisation/environment. When an entity is identified in the extracted text (step S106), the method may comprise: obtaining, for the new data item, an identifier for the new data item; and adding an index entry to the data item and entity index, wherein the index entry comprises the identifier for the new data item and the entity identifier for each entity named within content of the new data item (step S108). The process then continues when another new data item has been identified in the data storage device (step S110).

The method may further comprise: adding information about a notification policy for the entity in the index entry, wherein the notification policy comprises a condition for generating a data incident notification.

The method may further comprise: adding information about a risk level associated with the entity to the index entry.

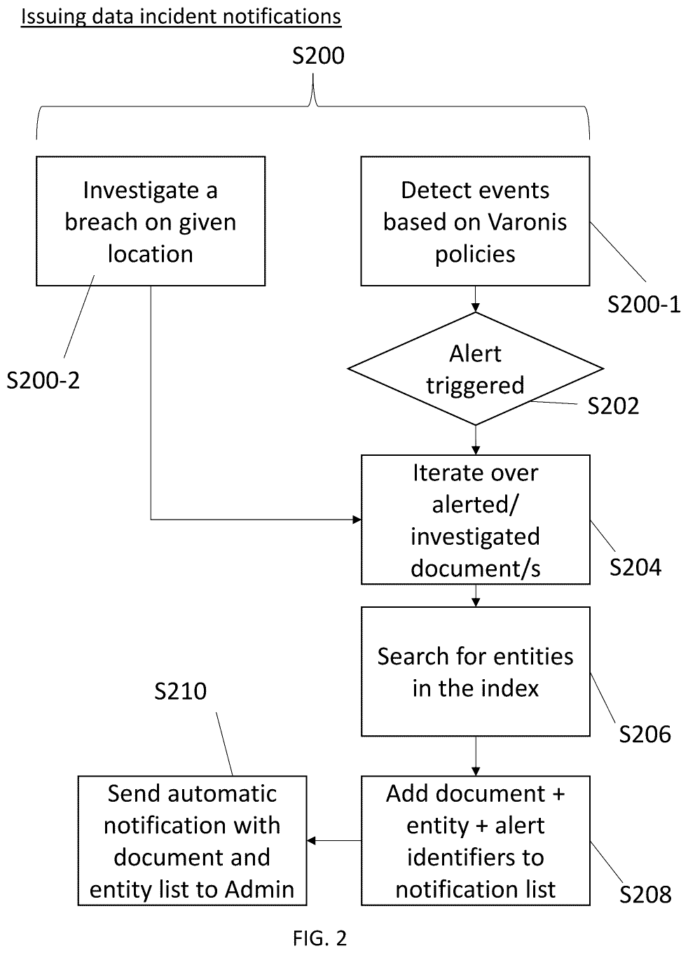

FIG. 2 is a block diagram of a process to generate data incident notifications using a data item and entity index. The process may be a computer-implemented method for automatically issuing data incident notifications. The method may comprise: determining an incident has occurred with respect to at least one data storage device storing a plurality of data items (step S200, S204); obtaining a data item and entity index for the at least one data storage device, wherein, for each data storage device, the data item and entity index comprises a plurality of index entries, wherein each index entry comprises an identifier for one data item of the plurality of data items stored by the data storage device together with an entity identifier for each entity named within content of each data item; generating, using the obtained data item and entity index for the at least one data storage device, a notification list comprising each data item that names at least one entity, and the corresponding entity identifier of the entity (steps S206 and S208); and determining, for each entity identifier in the notification list, whether to generate a data incident notification.

Step S200 may comprise using predefined alert triggers, which are designed to detect specific events or conditions related to data security, access, or compliance. As mentioned above, the alert triggers may be based on data management policies, which may contain conditions that trigger the search and notification process. There may be an option to trigger the search and entity notification process manually, by providing a set of locations to search in (in case of manual breach investigation).

The method may further comprise: transmitting the generated notification list to a system administrator (step S210), thereby enabling the system administrator to notify each entity about the data items in which they are named and that are subject to the incident. This may be advantageous because instead of automatically sending notifications to each entity immediately, the system administrator can decide whether the incident is serious enough to inform the entity, or can inform entities based on a priority order or seriousness level. This can be useful because it may avoid mass-panic and ensure that more serious breaches or violations are actioned first.

The step of transmitting the generated notification list may involve: for each identified entity, leveraging the source CSV containing additional details (such as email addresses); and automatically generating email notifications to the designated administrators. The email notifications may include the following information: impacted data items (i.e. a list of the data items associated with the entity and which are impacted by the incident); and a list of entities potentially impacted. Notification may be done in two ways: (i) an email may be sent to registered accounts, such as administrators, security officers, with a list of all documents and entities, or (ii) a notification may appear in an “action center” application, that could be reviewed at any time by the administrator. For every entity in the notification, it should be possible to trigger full profile search, and get a list of every data item containing the entity using the index.

Generating, using the obtained data item and entity index for the at least one data storage device, a notification list (step S206) involves compiling a list of related entities along with the corresponding documents. This list provides a clear overview of the impact of the alert.

There are different ways that occurrence of an incident at step S200 can be determined.

In one example, determining an incident has occurred may comprise: receiving an alert (step S202) that a data policy associated with at least one data item stored by the at least one data storage device has been violated. In this example, the alert arises from within the system/environment being monitored itself (i.e. the system or environment in which the data storage devices are located). For example, at least one data management policy may be applied to data items. The data management policy may be any security and/or data retention policy. For example, the data management policy may be a policy that prevents certain data items from being transmitted outside of the environment, or that controls who can access the data items within the environment, or that controls how long data items should be retained before they can be deleted/purged, or moved from primary storage to secondary or tertiary storage. The data management policy may be used to implement national or regional regulation or law, such as the European Union's General Data Protection Regulation (GDPR), or the USA's Data Privacy Protection laws. The alert may then be raised based on a violation of a data management policy (step S200-1).

That is, there may be an Alert Trigger Mechanism. When an alert is triggered in relation to a specific data item or set of data items (e.g., unauthorized access, suspicious activity, data leakage), the alert may cause a search of the index to be performed based on data item(s) which triggered the alert. The data management policy, type of incident that caused the alert to be triggered, and the risk level of each identified entity may be used to determine whether to generate a notification automatically or to ignore the alert. For example: Policy X was triggered by an unauthorized access event with respect to a file. The file includes entities with a high risk profile. This means a notification is to be generated. In another example: Policy Y was triggered by modified file event. The file includes entities with a low risk profile. In this case, a notification will not be generated.

Generating a notification list may comprise: identifying, in the index, an index entry corresponding to the at least one data item; selecting, from each identified index entry, each index entry comprising an entity identifier; and extracting, for each selected index entry, the identifier for the data item and the entity identifier for each entity named within content of the data item. In other words, the index may be used to quickly determine which of the impacted data items names an entity, so that a notification list can be generated that includes information about the impacted data items and the named entity. Thus, the notification list does not include data items that do not name entities within their content.

Determining, for each entity identifier in the notification list, whether to generate a data incident notification may comprise: retrieving, for the entity identifier, a notification policy for the entity corresponding to the entity identifier, wherein the notification policy comprises a condition for generating a data incident notification. In other words, each entity may be associated with a notification policy that specifies when a data incident notification should be issued. This may advantageously ensure that for some low-level individuals in an organisation notifications are not issued for all incident types as this may not be necessary, or may ensure that notifications are issued for many/all incident types for high-level individuals (e.g. C-suite). This can ensure notification traffic is optimised.

When the condition for generating a data incident notification is satisfied, the method may further comprise: transmitting, for the entity, the identifier for each data item in which the entity is named, and the entity identifier to a system administrator.

In some cases, retrieving a notification policy for the entity may comprise: retrieving a specific notification policy for the entity. Thus, a notification policy that is specific to the entity may exist. This may be appropriate for certain individuals in an organisation, e.g. C-suite.

In other cases, retrieving a notification policy for the entity may comprise: determining a risk level associated with the entity; and retrieving a notification policy based on the determined risk level. Thus, entities may be associated with a risk level (e.g. no risk, low risk, medium risk, high risk), and a notification policy that is associated with each risk level may exist. This may be an efficient way to specify notification policies for an organisation.

Determining a risk level associated with the entity may comprise determining any of: a risk level of the entity; a risk level of a role performed by the entity; a risk level of a group of which the entity is a member.

When the notification list contains two or more entities, the method may further comprise: ordering the two or more entities into an order based on the determined risk level of the entities; and transmitting, based on the order of the entities, the identifier for each data item in which each entity is named, and the entity identifier to a system administrator. Thus, information may be ordered based on risk level, so that the system administrator can take action based on the ordered information, which ensures high risk level entities are notified before low risk level entities. This is also useful because the system administrator may otherwise not know which entities are priorities.

In another example, determining an incident has occurred may comprise: receiving information from an external source that an incident has occurred with respect to the at least one data storage device (step S200-2). In this example, the alert arises from outside of the system/environment being monitored itself (i.e. the system or environment in which the data storage devices are located). Once the alert has been received, there are at least two techniques to determine which data storage device(s) has potentially been impacted. One technique involves receiving, within the alert itself, an indication of which data storage device(s) is (are) impacted. In this case, the alert may be received from a third party that for example, provides data loss prevention services. It will be understood that any external source may provide the alert. The method may then comprise scanning the data items stored by the indicated data storage device(s) to generate the notification list. An alternative technique involves the central server/platform device triggering an alert with respect to a specific data storage device, or with respect to a location in which one or more data storage devices are located.

That is, when the incident is reported by an external source, an investigation on breached location(s) (i.e. the impacted data storage devices) may be done manually to trigger a search process. There may be an option to trigger the search and entity notification process manually, by providing a set of locations to search in. An incident may be considered a high risk event—in such cases, a notification may be generated always, regardless of the entity list priority.

In this case, generating a notification list may comprise: identifying, in the index, each index entry comprising an entity identifier; and extracting, for each identified index entry, the identifier for the data item and the entity identifier for each entity named within content of the data item.

Determining, for each entity identifier in the notification list, whether to generate a data incident notification may comprise: automatically transmitting the generated notification list to a system administrator, thereby enabling the system administrator to notify each entity about the data items in which they are named and that are subject to the incident.

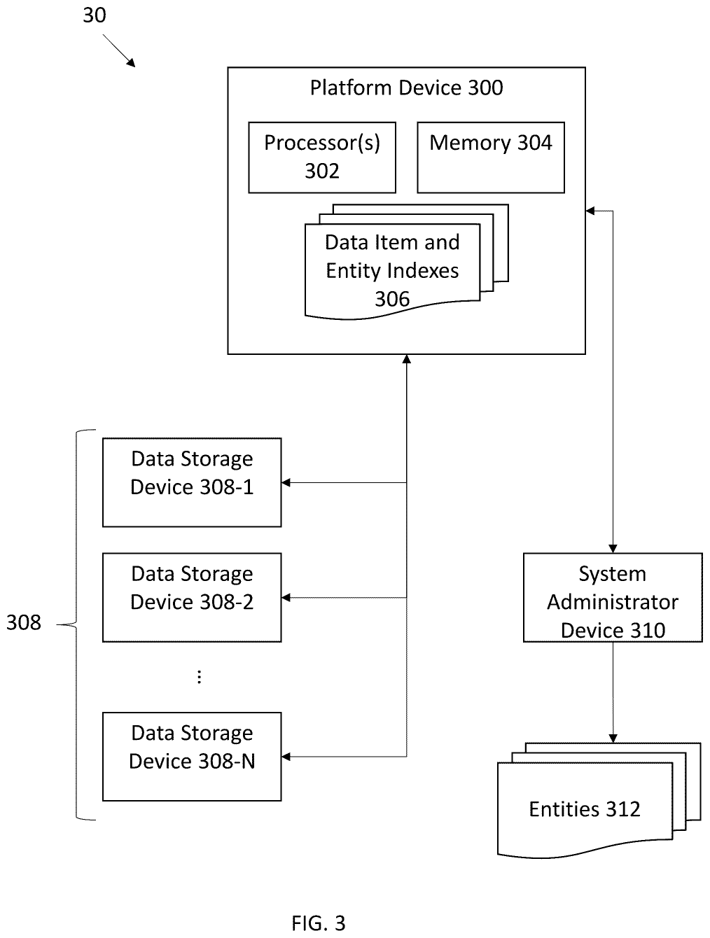

FIG. 3 is a block diagram of a system for automatically generating data incident notifications.

The system 30 comprises: a plurality of data storage devices 308. It will be understood that there may be any number of data storage devices within the system and that three data storage devices 308-1, 308-2 and 308-N are shown in FIG. 3 for the sake of simplicity. Each data storage device 308 stores a plurality of data items.

The system 30 comprises a platform device or central server 300. The platform device or central server is communicatively coupled to the data storage devices 308 and is arranged to automatically issue data incident notifications. The platform device or central server 300 comprises at least one processor 302 coupled to memory 304. The platform device or central server 300 comprises a data item and entity index 306 for each data storage device 308. For each data storage device 308, the data item and entity index 306 comprises a plurality of index entries, wherein each index entry comprises an identifier for one data item of the plurality of data items stored by the data storage device 308 together with an entity identifier for each entity named within content of each data item.

The at least one processor 302 is arranged for: determining an incident has occurred with respect to at least one of the data storage devices 308; obtaining the data item and entity index 306 for the at least one data storage device 308 where the incident has occurred; generating, using the obtained data item and entity index 306 for the at least one data storage device 308, a notification list comprising each data item that names at least one entity 312, and the corresponding entity identifier of the entity; and determining, for each entity identifier in the notification list, whether to generate a data incident notification.

In some cases, the platform device or central server 300 may issue, for at least one entity identifier in the notification list, a data incident notification responsive to determining a data incident notification is to be issued for the at least one entity identifier. That is, when it is determined that a data incident notification is to be generated with respect to a specific entity identifier, the platform device 300 issues the required data incident notification itself, or may instruct another device in the system 30 to do so.

The system 30 may further comprise a system administrator device 310, which may be operated by a human operator or may be automated. In some cases, the platform device or central server 300 may: transmit the generated notification list to the system administrator device 310, thereby enabling the system administrator device 310 to notify each entity 312 about the data items in which they are named and that are subject to the incident. In some cases, this may comprise sending a notification to a device or application used by an entity 312, e.g. a text message or email sent to their smartphone. This may be advantageous because instead of automatically sending notifications to each entity immediately, the system administrator device 310 can decide whether the incident is serious enough to inform the entity, or can inform entities based on a priority order or seriousness level. This can be useful because it may avoid mass-panic and ensure that more serious breaches or violations are actioned first.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A computer-implemented method for automatically issuing a data incident notification, the method comprising:
determining an incident has occurred with respect to at least one data storage device that stores a plurality of data items;
obtaining a data item and entity index for the at least one data storage device, wherein, for each data storage device, the data item and entity index comprises a plurality of index entries, wherein each index entry comprises an identifier for one data item of the plurality of data items stored by the data storage device together with an entity identifier for each entity named within content of each data item;
generating, using the obtained data item and entity index for the at least one data storage device, a notification list comprising each data item that names at least one entity, and the corresponding entity identifier of the entity; and
determining, for each entity identifier in the notification list, whether to generate a data incident notification.

2. The method of claim 1 further comprising, for at least one entity identifier in the notification list, issuing a data incident notification responsive to determining a data incident notification is to be generated for the at least one entity identifier.

3. The method of claim 1 further comprising:
transmitting, responsive to determining a data incident notification is to be generated, the generated notification list to a system administrator, thereby enabling the system administrator to notify each entity about the data items in which they are named and that are subject to the incident.

4. The method of claim 1 wherein determining an incident has occurred comprises:
receiving an alert that a data policy associated with at least one data item stored by the at least one data storage device has been violated.

5. The method of claim 4 wherein generating a notification list comprises:
identifying, in the index, an index entry corresponding to the at least one data item;
selecting, from each identified index entry, each index entry comprising an entity identifier; and
extracting, for each selected index entry, the identifier for the data item and the entity identifier for each entity named within content of the data item.

6. The method of claim 5 wherein determining, for each entity identifier in the notification list, whether to generate a data incident notification comprises:
retrieving, for the entity identifier, a notification policy for the entity corresponding to the entity identifier, wherein the notification policy comprises a condition for generating a data incident notification.

7. The method of claim 6 wherein when the condition for generating a data incident notification is satisfied, the method further comprises:
transmitting, for the entity, the identifier for each data item in which the entity is named, and the entity identifier to a system administrator.

8. The method of claim 6 wherein retrieving a notification policy for the entity comprises:
retrieving a notification policy that is pre-determined for the entity.

9. The method of claim 6 wherein retrieving a notification policy for the entity comprises:
determining a risk level associated with the entity; and
retrieving a notification policy based on the determined risk level.

10. The method of claim 9 wherein determining a risk level associated with the entity comprises determining any of: a risk level of the entity; a risk level of a role performed by the entity; a risk level of a group of which the entity is a member.

11. The method of claim 9 wherein, when the notification list contains two or more entities, the method further comprises:
ordering the two or more entities into an order based on the determined risk level of the entities; and
transmitting, in a same order as the order of the entities, the identifier for each data item in which each entity is named, and the entity identifier to a system administrator.

12. The method of claim 1 wherein determining an incident has occurred comprises:
receiving information from an external source that an incident has occurred with respect to the at least one data storage device.

13. The method of claim 12 wherein generating a notification list comprises:
identifying, in the index, each index entry comprising an entity identifier; and
extracting, for each identified index entry, the identifier for the data item and the entity identifier for each entity named within content of the data item.

14. The method of claim 13 wherein determining, for each entity identifier in the notification list, whether to generate a data incident notification comprises:
automatically transmitting the generated notification list to a system administrator, thereby enabling the system administrator to notify each entity about the data items in which they are named and that are subject to the incident.

15. A system for automatically issuing a data incident notification, the system comprising:
a plurality of data storage devices, each data storage device storing a plurality of data items;
a data item and entity index for each data storage device, wherein, for each data storage device, the data item and entity index comprises a plurality of index entries, wherein each index entry comprises an identifier for one data item of the plurality of data items stored by the data storage device together with an entity identifier for each entity named within content of each data item; and
at least one processor coupled to memory, arranged for:
determining an incident has occurred with respect to at least one of the data storage devices;
obtaining the data item and entity index for the at least one data storage device where the incident has occurred;
generating, using the obtained data item and entity index for the at least one data storage device, a notification list comprising each data item that names at least one entity, and the corresponding entity identifier of the entity; and
determining, for each entity identifier in the notification list, whether to generate a data incident notification.

16. A computer-implemented method for automatically generating a data item and entity index for use in issuing data incident notifications, the method comprising:
receiving an update whenever a new data item has been stored in a data storage device;
obtaining, for the new data item, an identifier for the new data item;
obtaining an entity identifier for each entity named within content of the new data item; and
adding an index entry to the data item and entity index, wherein the index entry comprises the identifier for the new data item and the entity identifier for each entity named within content of the new data item.

17. The method of claim 16 wherein obtaining an entity identifier comprises:
obtaining a list of entities and corresponding entity identifiers;
determining whether any entities in the obtained list appear in the content of the new data item; and
extracting from the list, when an entity appears in the content, the entity identifier of the entity.

18. The method of claim 16 further comprising:
adding information about a notification policy for the entity in the index entry, wherein the notification policy comprises a condition for generating a data incident notification.

19. The method of claim 16 further comprising:
adding information about a risk level associated with the entity to the index entry.
